(19) United States
(12) Patent Application Publication
(10) Pub. No.: US 2012/0243955 A1
(43) Pub. Date: Sep. 27, 2012

(54) Line Boring Jig

(76) Inventor: Brian Cross, Greenwood Lake, NY (US)

(21) Appl. No.: 13/430,282

(22) Filed: Mar. 26, 2012

Related U.S. Application Data
(60) Provisional application No. 61/465,887, filed on Mar. 25, 2011.

(51) Int. Cl. B23B 47/28

(52) U.S. Cl. 408/72 B

(57) ABSTRACT

The invention provides an assistive device designed for use in building adjustable shelving comprising a rectangular unit fashioned from a durable oak wood or aluminum material. Vertically lined along the surface of the Jig, are a series of holes are drilled linearly at one and one half inch intervals. A specialized drill bit with an integrated shoulder or adjustable stop ensures the hole is drilled at the desired depth.

### CLAIM OF PRIORITY

This patent application claims priority under 35 USC 119 (e) (1) from U.S. Provisional Patent Application Ser. No. 61/465,887 filed Mar. 25, 2011, of common inventorship herewith entitled, “Line Boring Jig.”

### FIELD OF THE INVENTION

The present invention pertains to the field of construction, and more specifically to the field of hand tools for accurately drilling shelf holder holes.

### BACKGROUND OF THE INVENTION

The prior art has put forth several designs for a hand tool for drilling holes. Among these are:

U.S. Pat. No. 5,807,036 to Tad K. Lostlen describes an adjustable drill rig for precisely locating and drilling one or more holes in a workpiece such as a kitchen component such as a door, drawer or side panel. In one embodiment the drill rig is a T-shaped flat structure with measurement rules on each of the stem and crossbar portions. Movable guide means are on the T-stem and T-crossbar portions allowing the drill rig to be positioned precisely to drill holes at the best locations on the item being installed.

U.S. Pat. No. 5,560,408 to Charles DiFranco describes a planar hole guide for boring a series of holes in a work piece. This guide is used with a plunge router having a working face and a motor driven cutter and a guide bushing having a diameter protruding from the working face. The guide's purpose is to precisely position and drill holes with predetermined spacing from an end and an edge of the work piece.

U.S. Pat. No. 5,064,321 to Gary D. Barnes describes a tooling plate having a plurality of columns of holes, which can be quickly and easily configured as a jig. Every second column contains threaded holes and the other columns contain unthreaded holes for receiving alignment pins to produce a jig suitable for aligning a work piece. The threaded holes are utilized by clamps that hold the work piece in place and by an alignment bar to align the work piece along any desired direction parallel to a front face of the tooling plate.

None of these prior art references describe the present invention.

### SUMMARY OF THE INVENTION

It is an object of the present invention to provide an assistive hand tool for building and installing adjustable shelving.

### BRIEF DESCRIPTION OF THE DRAWINGS

FIG. 1 is top perspective view showing approximate dimensions of the present invention and a specialized drill bit.

FIG. 2 is a front perspective of a cabinet illustrating the placement of the present invention inside the cabinet for lining up where holes are to be drilled for adjustable shelves.

FIG. 3A is top dimensional view of the line boring jig of the present invention in three quarter inch thick oak.

FIG. 3B is a side dimensional view of the line boring drill bit of the present invention shown in FIG. 3A.

FIG. 4A is top dimensional view of the line boring jig of the present invention in aluminum.

FIG. 4B is a side dimensional view of the line boring drill bit of the present invention shown in FIG. 4A.

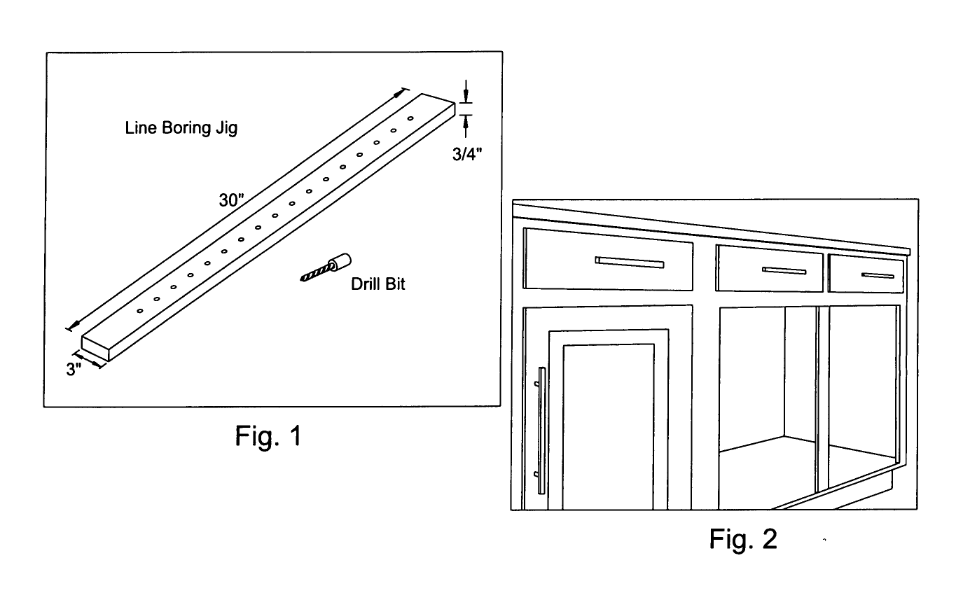

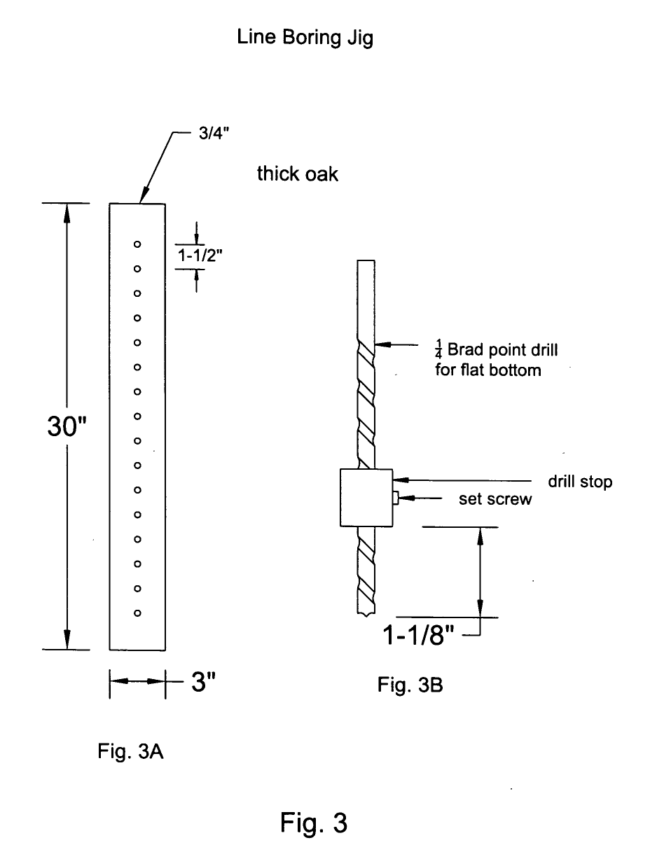

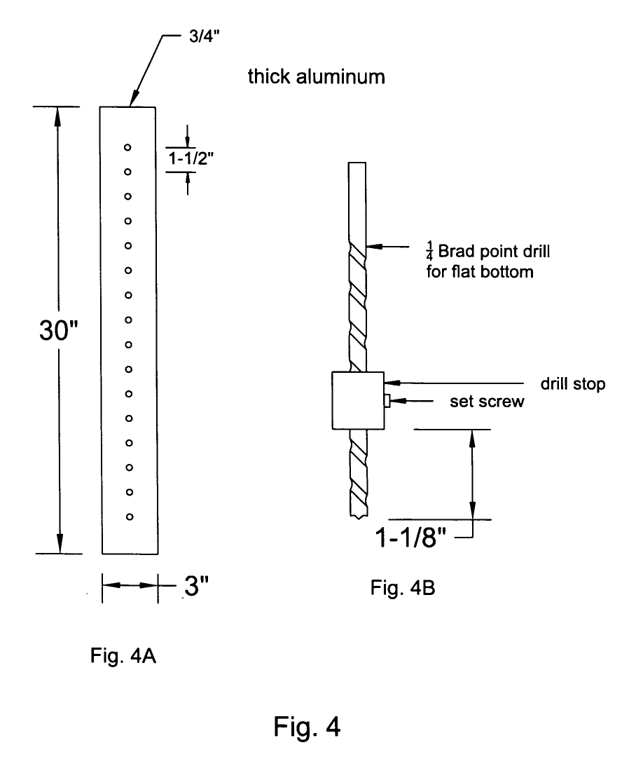

### DETAILED DESCRIPTION OF THE INVENTION

The present invention, hereinafter referred to as the Line Boring Jig, is an assistive device designed for use in building adjustable shelving. A rectangular unit fashioned from a durable oak wood or aluminum material, this product measures approximately thirty inches in length, three inches in width, and three quarters of an inch in depth. Vertically lined along the surface of the Jig, a series of holes are drilled linearly at one and one half inch intervals. These holes begin approximately three inches from each end of the unit. In this manner, the Line Boring Jig is employed as a measuring guide from each end of the unit. The Line Boring Jig is placed flush against the surface that is to be drilled. A specialized drill bit with an integrated shoulder to stop the cut at one and one eighth inch is included to further facilitate use of the device. The three quarter inch Line Boring Jig, used in conjunction with the specialized drill bit, drills a one quarter inch diameter hole three eights inch deep for the shelf peg. This prevents the user from drilling through the side of a one half inch thick cabinet. The device can also be configured to work on thicker material. In an embodiment, the drill bit but has a moveable stop for adjusting the depth of the hole to be drilled.

Depending upon the amount of space one desires for cabinet shelving or other types of shelves for display, the user marks the spots to be drilled using the Line Boring Jig and then drills into those marked spots. Portable and lightweight, the Line Boring Jig can be placed on to a countertop in a kitchen undergoing renovation or in a garage shop. The portability of the present invention allows professionals to easily transport the Line Boring Jig from job to job and complete the work on site. This not only saves time, but also allows professionals to pass time and money savings on to their clients. The accurate measurement from using Line Boring Jig ensures a professional installation and excellent functionality for all shelving projects. The three inch width of the Line Boring Jig allows consumers to place this device at the front and rear edges of their project placing would-be holes one and one half inch from the edge.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. An assistive hand tool system for building and installing adjustable shelving, comprising:
a) an elongate rectangular device having a first end and a second end and having a plurality of holes drilled linearly at one and one half inch intervals, wherein the first hole is placed approximately three inches from the first end and the last hole is placed approximately three inches from the second end of the device; and
b) a drill bit having an integrated shoulder to stop the cut at one a specified depth.

2. The device of claim 1 wherein the specified depth is one and one eighth inches.

3. The device of claim 1 wherein the device measures approximately thirty inches in length, three inches in width, and three quarters of an inch in depth.

4. An assistive hand tool system for building and installing adjustable shelving, comprising:
a) an elongate rectangular device a first end and a second end and having a plurality of holes drilled linearly at one and one half inch intervals, wherein the first hole begins approximately three inches from the first end and the last hole is placed approximately three inches from the second end of the device; and
b) a drill bit having a moveable stop for adjusting the depth of the hole to be drilled.

4. The device of claim 3 wherein the device measures approximately thirty inches in length, three inches in width, and three quarters of an inch in depth.

5. The device of claim 1 made of oak or aluminum.

6. The device of claim 3 made of oak or aluminum.
